(19) United States
(12) Patent Application Publication
(10) Pub. No.: US 2016/0233041 A1
(43) Pub. Date: Aug. 11, 2016

(54) SWITCH MODULE OF BUILT-IN ANTI-SURGE DISCONNECTION STRUCTURE

(71) Applicants: YI-HSIANG WANG, TAOYUAN CITY (TW); I-YING WANG, TAOYUAN CITY (TW)

(72) Inventors: YI-HSIANG WANG, TAOYUAN CITY (TW); I-YING WANG, TAOYUAN CITY (TW)

(21) Appl. No.: 14/617,000

(22) Filed: Feb. 9, 2015

(51) Int. Cl. H01H 61/02; H01H 13/14; H01H 89/04; H02H 3/08

(52) U.S. Cl. CPC H01H 61/02; H02H 3/08; H01H 13/14; H01H 89/04; H01H 2223/00

(57) ABSTRACT

A switch module of built-in anti-surge disconnection structure mainly comprises an overcurrent protection switch and has an anti-surge and disconnection structure ingeniously built inside the heat-resisting housing. The present invention comprises at least one spring, at least one band, at least one metal oxide varistor, at least one thermo-sensitive piece, and a pushing rod. When the first connecting point is contacting the second connecting point and an overvoltage occurs, the temperature of the metal oxide varistor would suddenly rise up to a pre-determined degree, causing the thermo-sensitive piece to melt, loosening the band, counterbalancing the compressing force on the spring and further displacing the pushing rod upwardly, therefore forcing the first connecting point detaching from the second connecting point and turning off the switch instantly without having the binary alloy conductive plate deformed or being displaced, so as to ensure more of electricity safety.

### BACKGROUND OF THE INVENTION

1. Field of the Invention

The present invention relates to a switch module of built-in anti-surge disconnection structure, particularly to an overcurrent protection switch that has anti-surge and disconnection structures built inside.

2. Description of the Related Art

FIGS. 1A and 1B disclose a conventional overcurrent protection switch 10, comprising a housing 11 with a press button 12 on the top, a first terminal 12a, a second terminal 12b, a third terminal 12c separately arranged at the bottom, and a moving element 14. The first terminal 12a has a bimetal plate 13 and a first contact 131; the second terminal 12b has a second contact 121 corresponding to the first contact 131. The moving element 14 has one end linking the bottom of the press button 12 and the other linking the moving terminal of the bimetal plate 13, whereby the pressing of the press button 12 actuates the first contact 131 connecting to the second contact 121 and therefore turns on the device; while overcurrent occurs, the bimetal plate 13 deforms due to high degree of temperature and disconnects the first and second contact 131, 121, turning off the device so as to form an overcurrent protection switch 10. Such structure can be found in Taiwan patent applications No. 540811, 367091, 320335, 262168, and 208384. However, the structure disclosed above aims at protection from overcurrent situation but is not able to protect the device when sudden overvoltage such as lightning stroke occurs.

Therefore, for safety concern, a usual solution to the defect is to parallel connect to a metal oxide varistor, and to connect to a thermal fuse in series.

FIG. 2 is the invention of U.S. Pat. No. 8,643,462. It discloses an anti-surge switch module applied in an electric system. The switch module comprises a power switch 105, an insulating member 106, a surge absorber 107 and a pyrocondensation belt 108. The insulating member 106 engages with the power switch 105 that abutting against the surge absorber 107; and the pyrocondensation belt 108 ties the surge absorber 107 and the insulating member 106 together so that it could contract when receiving the heat from the surge absorber 107 and thus turn off the power switch 105 under certain degree of contracting. However, the insulating member 106, the surge absorber 107 and the pyrocondensation belt 108 are not disposed inside the power switch 105 but are connected outside, failing to form a complete device with the power switch 105.

In short, the structures disclosed above have shortcomings as uncertain quality, possible exceeding heat, slow reaction, large volumes, and complicated composition, and they require more constructing space and procedures. Besides, the protection device has to be connected independently outside instead of having one inside.

In UL 1449 3^{rd} Edition (2009) Type 4 was added to Surge Protective Devices (SPDs) requirements. The 3^{rd} Edition also includes the Low voltage Surge Arrestres under 1000 V in the requirements, and the title is also altered from Transient Voltage Surge Suppressors into Surge Protective Devices. This shows the importance of the components being integrated and the surge arrestres function of the device.

Hence, it is desirable to construct an anti-surge disconnection structure built inside a heat-resisting and fireproof housing of an overcurrent protection switch 10 so that the disconnection could be operated successfully and instantly when an overload occurs.

### SUMMARY OF THE INVENTION

A primary object of the present invention is to provide a switch module of built-in anti-surge disconnection structure that has the original function of overcurrent protection and further includes the anti-surge and disconnection features to ensure more of electricity safety.

Another object of the present invention is to have the anti-surge disconnection structure built inside the switch module for more safety and easy assembly with other electronic devices.

To achieve the objects mentioned above, the present invention comprises a housing with a press button at the top thereof, a first conductive plate arranged at the lower section thereof as the positive electrode for input, a second conductive plate as the positive electrode for output and a third conductive plate as the negative electrode for input, where said first conductive plate is connected to a binary alloy conductive plate that has a spring leaf and a first connecting point in the middle section thereof, and said second conductive plate has a second connecting point on the surface thereof corresponding to said first connecting point; a moving rod linking up the bottom of said press button with one end and a movable end of said binary alloy conductive spring leaf with the other end, whereby the press button would press said binary alloy conductive plate and the spring leaf thereon to connect the first connecting point with the second connecting point, turning on the switch, and when current overload occurs, the binary alloy conductive plate would deform due to high temperature, detaching said first connecting point on the spring leaf from the second connecting point, thus turning off the switch, so as to form an overcurrent protection switch; wherein

an anti-surge disconnection structure is built inside the housing under the spring leaf, including: at least one metal oxide varistor with a top surface and a bottom surface, and a set of conductive elements; a spring disposed on either surface of the metal oxide varistor; a band having a first end and a second end arranged closely and correspondingly to compress the spring on the metal oxide varistor; at least one thermo-sensitive piece that is solid colloid to be adhered on the surface of the metal oxide varistor and to bond the first end and the second end for fixing the spring; a pushing rod disposed under the bottom of the spring leaf;

whereby when the first connecting point is contacting the second connecting point and an overvoltage occurs, the temperature of said metal oxide varistor would suddenly rise up to a pre-determined degree and the thermo-sensitive piece would melt, then the band would loosen, counterbalancing the compressing force on the spring and further displacing the pushing rod upwardly, therefore forcing the first connecting point detaching from the second connecting point and turning off the switch without having the binary alloy conductive plate deformed or being displaced.

In addition, the thermos-sensitive is made of non-metal thermo-sensitive materials or metal compounds that are fast-acting in low temperature.

As structures disclosed above, the present invention complements the defect of a conventional overcurrent protection switch that it has to connect to a metal oxide varistor from the outside by having an anti-surge disconnection structure ingeniously built inside the heat-resisting and fireproof housing. When receiving exceedingly high voltages, the heating metal oxide varistor would instantly melt the thermo-sensitive piece down, loosening the band, counterbalancing the compressing force on the spring and further displacing the pushing rod upwardly, therefore forcing the first connecting point detaching from the second connecting point and turning off the switch immediately. Therefore, the present invention is not only overcurrent protective but also overvoltage protective and surge absorbing, ensuring more electricity safety and conveniences in using.

### BRIEF DESCRIPTION OF THE DRAWINGS

FIG. 1A is a perspective view of an overcurrent protection switch according to the prior art;

FIG. 1B is a section view of an overcurrent protection switch according to the prior art;

FIG. 2 is a perspective view of an anti-surge and disconnection structure according to the U.S. Pat. No. 8,643,462;

FIG. 3 is a sectional view of the present invention in a preferred embodiment in an OFF status;

FIG. 4 is a sectional view of the present invention in a preferred embodiment in an ON status;

FIG. 4A is a sectional view of line 4A-4A in FIG. 4;

FIG. 5 is an application example of the present invention illustrating the thermo-sensitive piece melting, loosening the band and displacing the pushing rod, further turning the switch off;

FIG. 5A is a sectional view of line 5A-5A in FIG. 5;

FIG. 6 is an exploded view of the major components of the present invention in a preferred embodiment;

FIG. 7A is a schematic diagram of the present invention with two metal dioxide varistors;

FIG. 7B is a schematic diagram of the present invention with three metal dioxide varistors;

FIG. 8 is a top perspective view of the present invention in a preferred embodiment; and

FIG. 9 is a bottom perspective view of FIG. 8

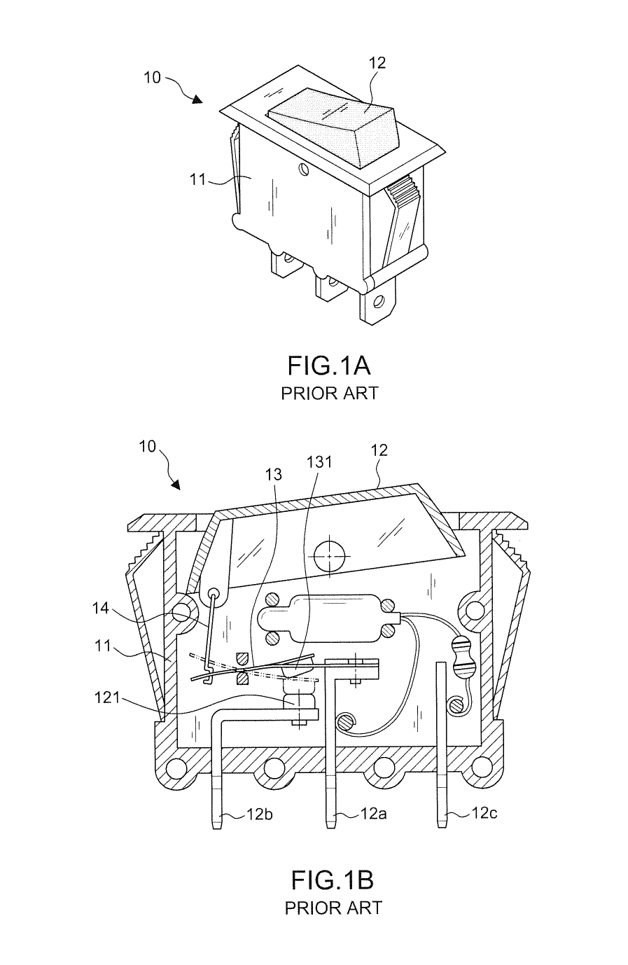

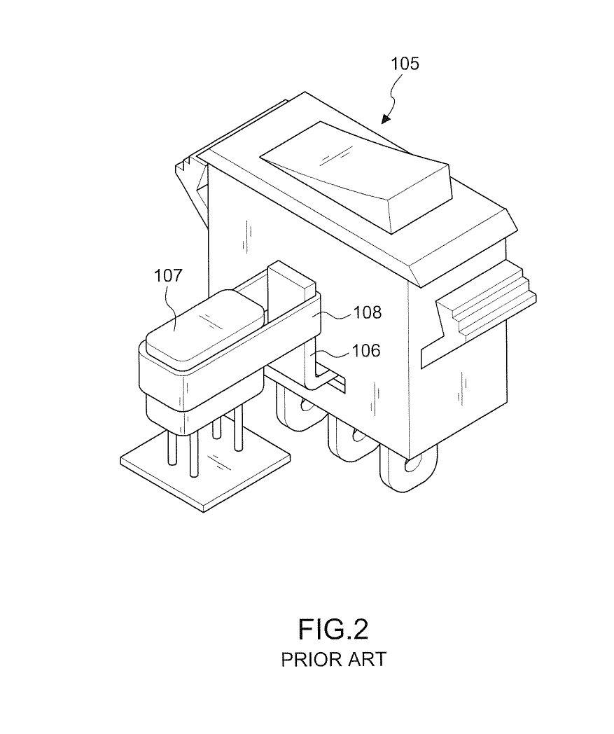

### DETAILED DESCRIPTION OF THE PREFERRED EMBODIMENT

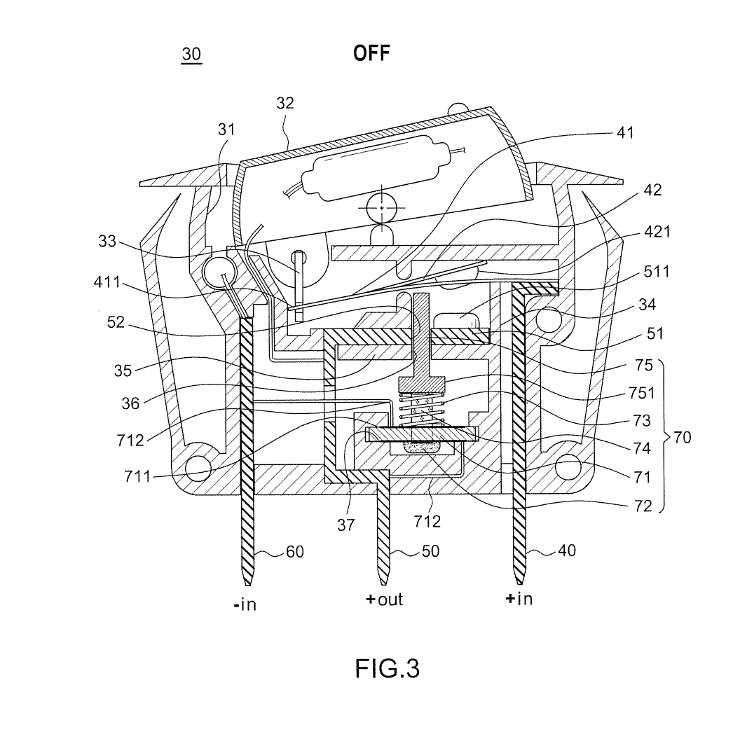

Referring to FIGS. 3-6, a preferred embodiment of the present invention comprises a housing 31 with a press button 32 at the top thereof, a first conductive plate 40 arranged at the lower section thereof as the positive electrode for input, a second conductive plate 50 as the positive electrode for output and a third conductive plate 60 as the negative electrode for input; the first conductive plate 40 is connected to a binary alloy conductive plate 41 that has a spring leaf 42 and a first connecting point 421 in the middle section thereof, and the second conductive plate 50 has a second connecting point 511 on the upper section 51 thereof corresponding to said first connecting point 421.

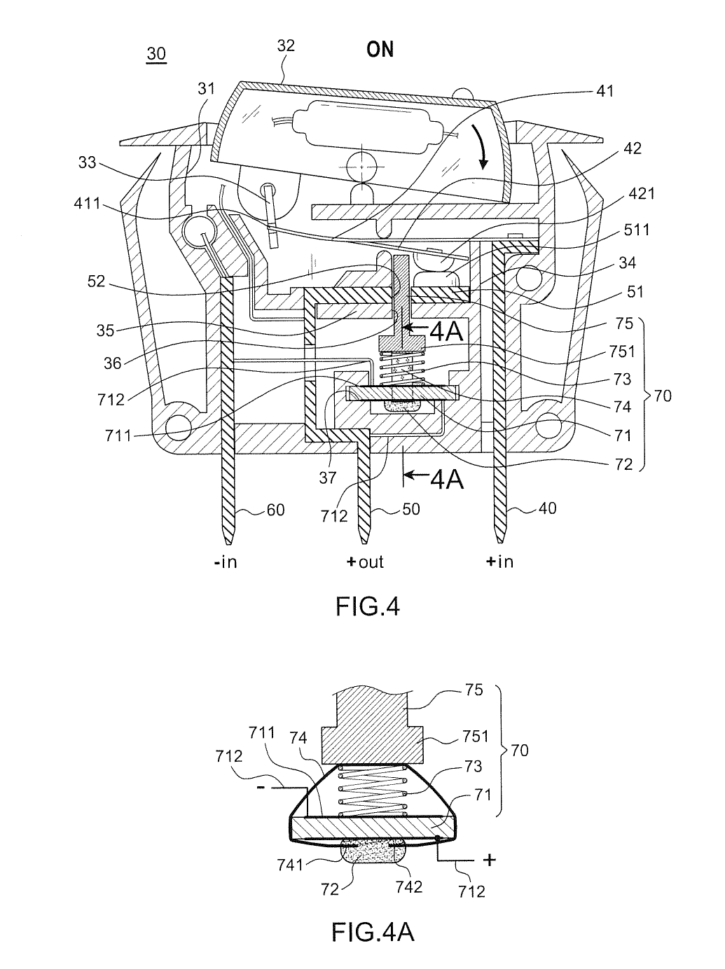

Also, it comprises a moving rod 33 linking up the bottom of said press button 32 with the top end thereof and a movable end 411 of said binary alloy conductive plate 41 with the bottom end, whereby the press button 32 would press said binary alloy conductive plate 41 to connect the first connecting point 421 with the second connecting point 511, forcing the spring leaf 42 to move downwardly and turning on the switch as illustrated in FIGS. 4 and 4A. When current overload occurs, the binary alloy conductive plate 41 would deform due to high temperature and leading the present invention back to the off status illustrated in FIG. 3. The first connecting point 421 is therefore detached from the second connecting point 511, turning off the switch, so as to form a switch module 30 comprised mainly by an overcurrent protection switch. However, such structure belongs to the prior art already.

The features of the present invention lies in the upper section 51 of the second conductive plate 50 having a gap 52 near the side of the second connecting point 511 in an applicable embodiment, and an anti-surge disconnection structure 70 being built inside the housing 31 under the spring leaf 42, including at least one metal oxide varistor 71, a spring 73, a band 74, at least one thermo-sensitive piece 72, and a pushing rod 75.

The metal oxide varistor 71 has a top surface and a bottom surface 711, and a set of conductive elements 712; the conductive elements 712 can be a conductive wire, a flexible piece, or an element extended from the metal oxide varistor 71.

The spring 7 3 is disposed on the top surface 71 1 of the metal oxide varistor 71. The band 74 compresses the spring 73 on the metal oxide varistor 71 with a first end 741 and a second end 742 arranged correspondingly, making it stayed in a shorter length than usual; it can be a banding, a cord, or a string.

The thermo-sensitive piece 72 is a solid colloid to be adhered on the surface of the metal oxide varistor 71 and to bond the first end 741 and the second end 742 for girdling and fixing the spring 73. In the embodiment, it can be made of non-metal thermo-sensitive materials or metal compounds that are fast-acting in low temperature, but is not limited to such application. In other words, the materials that would melt in certain degree which is lower than the high degree the metal dioxide varistor 71 would reach would work, whether conductive or not. Such compounds have firm melting point and the feature of fast-acting. On the other hand, the band 74 and the thermo-sensitive piece 72 are made of either metal or non-metal materials; for instance, a non-metal band 74 combing with a metal thermo-sensitive piece 72 would work, or both of them are made of the same thermo-sensitive materials. Such structure is already well known in the field.

The pushing rod 75 has the upper end thereof being disposed through the gap 52 of the upper section 51 of the second conductive plate 50, under the bottom of the spring leaf 42 when the first connecting point 421 of the spring leaf 42 is contacting the second connecting point 511. In this embodiment, it further includes a bottom 751 to be disposed against the top of the spring 73 but is not limited to such application; the pushing rod 75 having a wider contacting area than the top surface of the spring 73, or being combined or fixed with the spring 73 for synchronous upward displacement would be workable. The main function of the pushing rod 75 is to push and displace the spring leaf 42, and force the first connecting point 421 detaching from the second connecting point 511 when the switch module 30 is in unusual status.

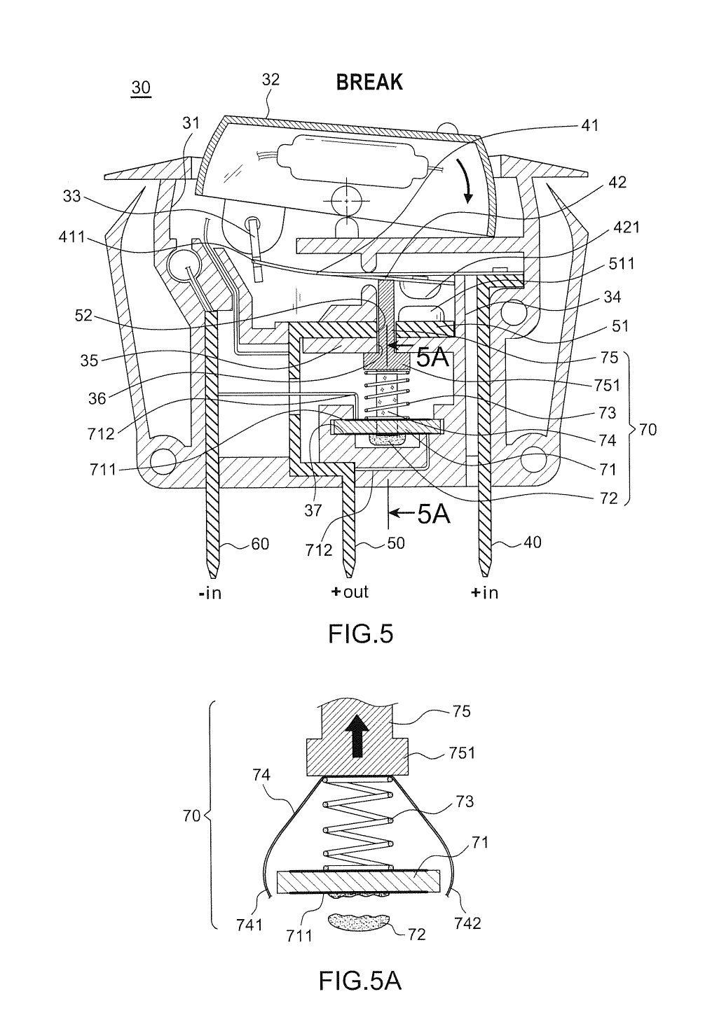

Further referring to FIGS. 5 and 5A, when the first connecting point 421 is contacting the second connecting point 511 and an overvoltage occurs, the temperature of said metal oxide varistor 71 would suddenly rise up to a degree higher than the melting point of the thermo-sensitive piece 72, and the thermo-sensitive piece 72 would melt, then the band 74 would loosen, counterbalancing the compressing force on the spring 73 and further displacing the pushing rod 75 upwardly, therefore forcing the first connecting point 421 detaching from the second connecting point 511 and turning off the switch without having the binary alloy conductive plate 41 deformed or being displaced.

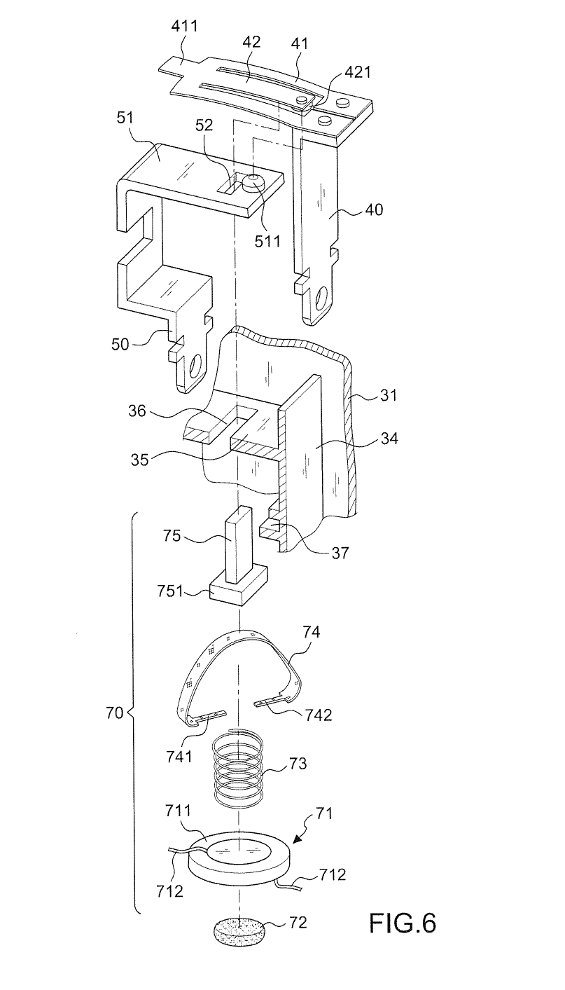

FIG. 6 is an exploded view of the main elements of the present invention. The anti-surge disconnection structure 70 mainly comprises at least one metal oxide varistor 71, at least one thermo-sensitive piece 72, at least one spring 73, at least one band 74, and a pushing rod 75. Meanwhile, with reference to FIGS. 3-5, the anti-surge disconnection structure 70 is arranged between the first conductive plate 40 and the second conductive plate 50. In the embodiment, the housing 31 has a vertical holding surface 34 and a horizontal positioning surface 35 arranged therein for the upper section 51 of the second conductive plate 50 to be disposed on the positioning surface 35, and the positioning surface 35 has a passage 36 arranged corresponding to the gap 52 of the upper section 51 for the pushing rod 75 to pass through. Furthermore, the housing 31 has two corresponding narrow grooves 37 arranged between the first and second conductive plates 40, 50 for both sides of the metal oxide varistor 71 to be engaged in position, so that the entire anti-surge disconnection structure 30 is steadily built inside the housing 30.

When an overvoltage occurs to the switch module 30 of the present invention, the temperature of the metal oxide varistor 71 instantly rises up to a pre-determined degree, melting the thermo-sensitive piece 72 on the upper surface 711 of the metal oxide varistor 71. A metal oxide varistor is an non-ohmic conductive component. The electric resistance of a metal oxide varistor depends on the external voltages. Therefore, the V-I characteristic curve of it is obviously non-linear, making it popularly used in the practical field for preventing the power supply system from the damages caused by sudden overvoltage. The thermo-sensitive piece 72 of the present invention would melt immediately when an overvoltage occurs and results in the instant rising of temperature of the metal oxide varistor 71, loosening the band 74, counterbalancing the compressing force on the spring 73 and further displacing the pushing rod 75 upwardly, therefore forcing the first connecting point 421 detaching from the second connecting point 511 and turning off the switch in a short time without having the binary alloy conductive plate 41 deformed or being displaced.

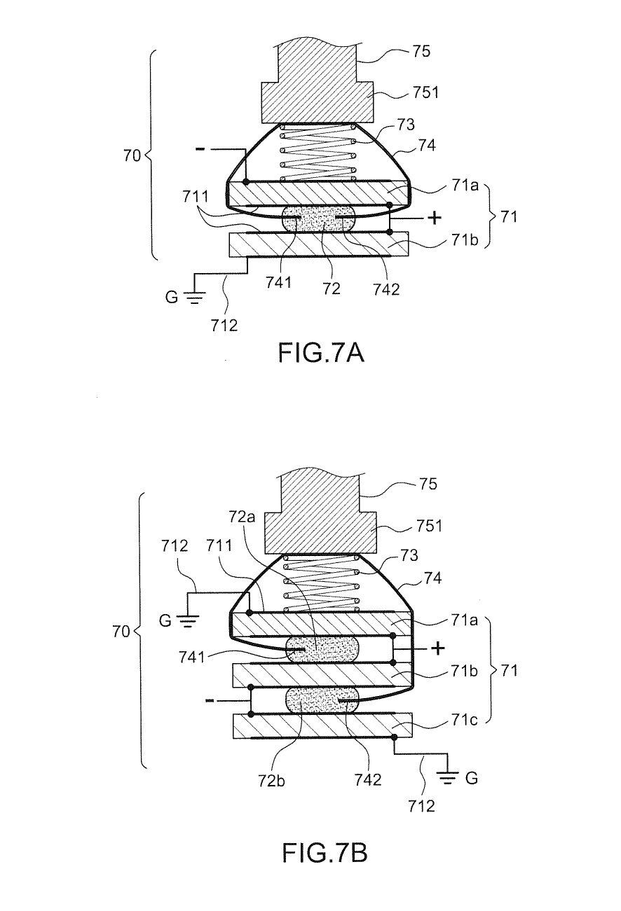

In the disclosed embodiment, there is one metal oxide varistor 71 but it is not limited to such application. In FIG. 7A, the present invention includes two parallel connected metal oxide varistors 71a, 71b to be combined with the band 74, enhancing the anti-surge function and enabling more rapid melting of the thermo-sensitive piece 72 with two heating surfaces when an overvoltage occurs. This also ensures more safety. Apart from this structure, in an applicable embodiment, one of the metal oxide varistors 71a, 71b could be connected to the ground with an end as well; in this way, there is another protection structure for the present invention.

FIG. 7B illustrates the present invention including three metal oxide varistors 71a, 71b, 71c to be combined with the band 74 for a three-wire circuit protection. The difference between the embodiments disclosed above is that a first thermo-sensitive piece 72a is fixing the first end 741 of the band 74 between the first and the second metal oxide varistors 71a, 71b, and a second thermo-sensitive piece 72b is fixing the second end 742 of the band 74 between the second and the third metal oxide varistors 71b, 71c. Each metal oxide varistor is connected to the live wire, neutral wire, and ground wire individually so that when an overvoltage occurs to any of which, it is able to disconnect the circuit. In addition, it is also applicable to parallel connect three metal oxide varistors for triple anti-surge and apply in two-wire circuit. In sum, the present invention may include one or more metal oxide varistors inside the housing 31.

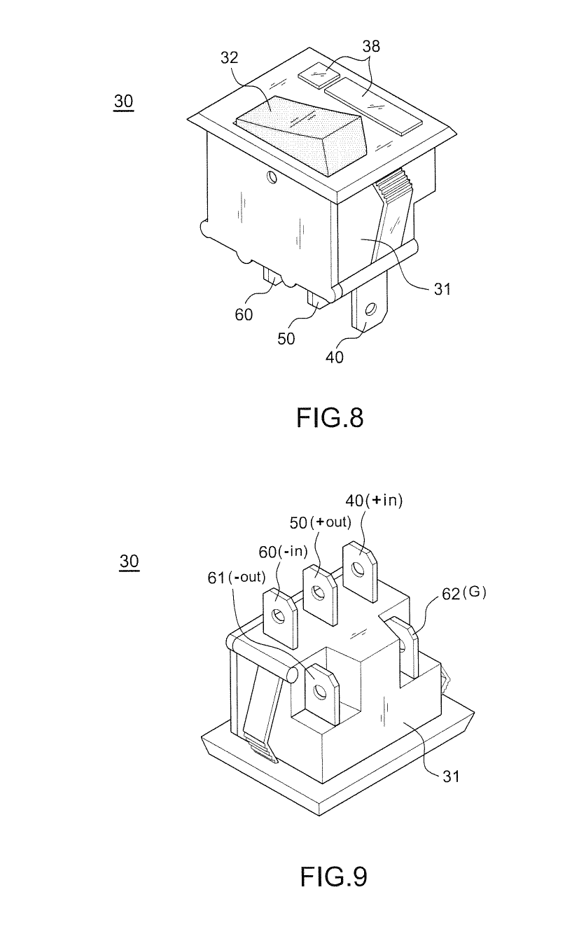

FIG. 8 is a top perspective view of the present invention in a preferred embodiment. In the embodiment, the housing 31 further includes a display unit 38 on the outside. After the thermo-sensitive piece 72 in the switch module 30 melted and turned it off, the display unit 38 would show the status of the switch module 30 by a LED bulb or a block; also, it is applicable to have the pushing rod 75 pushing the other negative electrode for simultaneously separating both the positive and negative electrodes and disconnect. Such structures can be easily achieved by a person who is familiar with the art.

FIG. 9 is a bottom perspective view of FIG. 8. In this embodiment, the housing 31 not only has the first conductive plate 40 as the positive electrode for input, the second conductive plate 50 as the positive electrode for output, and third conductive plate 60 as the negative electrode for input, but also has a fourth conductive plate 61 as the negative electrode for output and a fifth conductive plate 62 as the terrestrial pole G for the conductive elements 712 of the metal oxide varistor 71 to connect, so as to enhance the completeness of the present invention.

With structures disclosed above, the present invention complements the defect of a conventional overcurrent protection switch that it has to connect to a metal oxide varistor and a thermal fuse from the outside by having an anti-surge disconnection structure 70 ingeniously built inside so that when receiving exceedingly high voltages, the heating metal oxide varistor 71 would instantly melt the thermo-sensitive piece 72, loosening the band 74, counterbalancing the compressing force on the spring 73 and further displacing the pushing rod 75 upwardly, therefore forcing the connecting points to detach and turning off the switch immediately. Hence, the present invention has the original function of overcurrent protection and further has the overvoltage protection and anti-surge disconnection structures built inside, ensuring more electricity safety and conveniences in using.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A switch module of built-in anti-surge disconnection structure, comprising:
a housing with a press button at the top thereof, a first conductive plate arranged at the lower section thereof, a second conductive plate and a third conductive plate, where said first conductive plate is connected to a binary alloy conductive plate that has a spring leaf and a first connecting point in the middle section thereof, and said second conductive plate has a second connecting point on the surface of the upper section thereof corresponding to said first connecting point;
a moving rod linking up the bottom of said press button with one end and a movable end of said binary alloy conductive plate with the other end, whereby the press button would press said binary alloy conductive plate and the spring leaf thereon to connect the first connecting point with the second connecting point, turning on the switch, and when current overload occurs, the binary alloy conductive plate would deform due to high temperature, detaching said first connecting point on the spring leaf from the second connecting point, thus turning off the switch, so as to form an overcurrent protection switch; wherein
an anti-surge disconnection structure is built inside the housing under the spring leaf, including:
at least one metal oxide varistor with a top surface and a bottom surface, and a set of conductive elements;
a spring disposed on either surface of the metal oxide varistor;
a band having a first end and a second end arranged correspondingly to compress the spring on the metal oxide varistor;
at least one thermo-sensitive piece that is solid colloid to be adhered on the surface of the metal oxide varistor and to bond the first end and the second end for girdling and fixing the spring;
a pushing rod having the upper end thereof under the bottom of the spring leaf;
whereby when the first connecting point is contacting the second connecting point and an overvoltage occurs, the temperature of said metal oxide varistor would suddenly rise up to a pre-determined degree and the thermo-sensitive piece would melt, then the band would loosen, counterbalancing the compressing force on the spring and further displacing the pushing rod upwardly, therefore forcing the first connecting point detaching from the second connecting point and turning off the switch without having the binary alloy conductive plate deformed or being displaced.

2. The switch module of built-in anti-surge disconnection structure a s claimed in claim 1, wherein the thermos-sensitive is made of non-metal thermo-sensitive materials or metal compounds that are fast-acting in low temperature.

3. The switch module of built-in anti-surge disconnection structure as claimed in claim 2, wherein the band and the thermo-sensitive piece are made of either metal or non-metal materials.

4. The switch module of built-in anti-surge disconnection structure as claimed in claim 2, wherein the band and the thermo-sensitive piece are made of the same thermo-sensitive materials.

5. The switch module of built-in anti-surge disconnection structure as claimed in claim 1, wherein a vertical holding surface and a horizontal positioning surface are arranged inside the housing for the upper section of the second conductive plate to be disposed on the positioning surface.

6. The switch module of built-in anti-surge disconnection structure as claimed in claim 5, wherein the upper section of the second conductive plate has a gap near the side of the second connecting point, and the positioning surface has a passage arranged corresponding to the gap for the pushing rod to pass through.

7. The switch module of built-in anti-surge disconnection structure as claimed in claim 1, wherein the housing has two corresponding narrow grooves arranged between the first and second conductive plates for both sides of the metal oxide varistor to be engaged in position.

8. The switch module of built-in anti-surge disconnection structure as claimed in claim 1, wherein the pushing rod has a bottom to be disposed against the top of the spring.

9. The switch module of built-in anti-surge disconnection structure as claimed in claim 1, wherein there is one metal oxide varistor, and a thermo-sensitive piece is fixing a first end and a second end of a band to be tightly disposed on the surface of the metal oxide varistor.

10. The switch module of built-in anti-surge disconnection structure as claimed in claim 1, wherein there are two metal oxide varistors, and a thermo-sensitive piece is fixing a first end and a second end of a band to be disposed in-between.

11. The switch module of built-in anti-surge disconnection structure as claimed in claim 1, wherein there are three metal oxide varistors and two thermo-sensitive pieces; one of the thermo-sensitive pieces is fixing a first end of a band between the first and second metal oxide varistors, and the other thermo-sensitive piece is fixing a second end of the band between the second and the third metal oxide varistors.

12. The switch module of built-in anti-surge disconnection structure as claimed in claim 1, wherein on the outside, the housing further includes a display unit showing the status of the switch module, a fourth conductive plate as the negative electrode for output, and a fifth conductive plate as the terrestrial pole for the conductive element of the metal oxide varistor to connect.
